(19) United States
(12) Patent Application Publication
(10) Pub. No.: US 2026/0328382 A1
(43) Pub. Date: Oct. 22, 2026

(54) LIGHTING ASSEMBLY AND ELECTRONIC DEVICE

(71) Applicant: Harman International Industries, Incorporated, Stamford, CT (US)

(72) Inventor: James PYBUS, Shenzhen (CN)

(73) Assignee: Harman International Industries, Incorporated, Stamford, CT (US)

(21) Appl. No.: 19/650,122

(22) Filed: Apr. 16, 2026

(30) Foreign Application Priority Data
Apr. 18, 2025 (CN) 2025207534450

(51) Int. Cl. F21V 33/00; F21V 3/04; F21V 7/00; F21V 7/04; F21Y 115/10

(52) U.S. Cl. CPC F21V 33/0056; F21V 3/049; F21V 7/0025; F21V 7/04; F21Y 2115/10

(57) ABSTRACT

Disclosed are a lighting assembly and an electronic device. The lighting assembly includes: a light source panel having an elongated shape and provided with a plurality of light sources arranged along its longitudinal direction; a reflector having an elongated shape and spaced apart from and arranged to face the light source panel, the reflector including a plurality of reflective structures arranged along its longitudinal direction; and a light diffuser, made of a translucent material, surrounding the light source panel and the reflector laterally, and having an inner surface extending between the light source panel and the reflector and an outer surface opposite to the inner surface. The electronic device includes: a housing of the electronic device.

### CROSS-REFERENCE TO RELATED APPLICATIONS

This application claims foreign priority to CN Application No. CN 2025207534450 filed Apr. 18, 2025, the disclosure of which is hereby incorporated in its entirety by reference herein.

### TECHNICAL FIELD

The present disclosure relates to a lighting assembly and an electronic device including the lighting assembly.

### BACKGROUND

With the development in multi-functionality of modern audio equipment, integrated audio and visual effects have become an important direction for enhancing the user experience. Especially in the home cinema and personal audio equipment, the lighting effect and the audio effect of the audio system complement each other to jointly create an immersive experience.

Most of the existing audio lighting systems rely on traditional LED array illumination, but there are some problems with LED array illumination. For example, LED arrays can hardly provide a uniform lighting effect, which affects the user experience. While some solutions attempt to alleviate this problem by increasing the number of LEDs and arranging complex light diffusion devices, these solutions often require a large installation space or are costly, and the uniformity of their lighting effect needs further improvement.

Therefore, a lighting assembly with a simple structure, small volume, and low cost that is capable of providing uniform illumination effect is required to solve the technical problem.

### SUMMARY

An object of the present disclosure is to overcome at least some of the above problems in the prior art.

According to an aspect of the present disclosure, a lighting assembly is provided, including: a light source panel having an elongated shape and provided with a plurality of light sources arranged along its longitudinal direction; a reflector having an elongated shape and spaced apart from and arranged to face the light source panel, the reflector including a plurality of reflective structures arranged along its longitudinal direction; and a light diffuser, made of a translucent material, surrounding the light source panel and the reflector laterally, and having an inner surface extending between the light source panel and the reflector and an outer surface opposite to the inner surface.

According to one or more embodiments of the present disclosure, the plurality of reflective structures include a plurality of first reflective structures, each first reflective structure corresponding to one light source on the light source panel and arranged to face directly the corresponding light source.

According to one or more embodiments of the present disclosure, the plurality of reflective structures further include a plurality of second reflective structures, the second reflective structure being arranged between two adjacent first reflective structures.

According to one or more embodiments of the present disclosure, the light source panel is an LED panel, and the light sources are LED elements.

According to one or more embodiments of the present disclosure, the plurality of reflective structures of the reflector are of V-shaped structures.

According to one or more embodiments of the present disclosure, the reflector is a formed part coated with a reflective coating.

According to one or more embodiments of the present disclosure, the lighting assembly is used for an electronic device, and the lighting assembly further includes a support ridge, the support ridge being adapted to fasten the light source panel, the reflector, and the light diffuser to a housing of the electronic device via fasteners.

According to one or more embodiments of the present disclosure, the fasteners are a plurality of screws, each of the screws passing through corresponding holes in the support ridge, the reflector, the light diffuser, and the light source panel, for fastening the lighting assembly to the housing of the electronic device.

According to one or more embodiments of the present disclosure, the lighting assembly further includes a back cover configured to be connected to the support ridge.

According to one or more embodiments of the present disclosure, the electronic device is a speaker box.

According to an aspect of the present disclosure, an electronic device is provided, including: a housing of the electronic device; and a lighting assembly according to any of the above items, where the lighting assembly is mounted to the housing of the electronic device, and the housing of the electronic device has a transparent housing portion, with the outer surface of the light diffuser optically coupled to the transparent housing portion of the housing of the electronic device.

According to one or more embodiments of the present disclosure, the electronic device is a speaker box, the housing of the electronic device is a speaker box housing, and the speaker box includes one or more speakers.

According to one or more embodiments of the present disclosure, the speaker box housing includes a front housing and a rear housing, the lighting assembly being arranged on the rear housing, the rear housing including the transparent housing portion, and the one or more speakers being arranged on the front housing.

According to one or more embodiments of the present disclosure, the lighting assembly is arranged on the rear housing of the speaker box in a vertical direction.

According to one or more embodiments of the present disclosure, the lighting assembly further includes a support ridge, the support ridge configured to fasten the light source panel, the reflector, and the light diffuser to the housing of the electronic device via fasteners, and when the lighting assembly is connected to the electronic device, the housing of the electronic device and the lighting assembly form a continuous outer surface, providing an aesthetically pleasing appearance.

According to one or more embodiments of the present disclosure, the lighting assembly further includes a back cover, and the support ridge is provided with a recess shaped and sized to correspond to the back cover, so that when the back cover is connected to the support ridge, it forms a continuous outer surface with the support ridge, providing an aesthetically pleasing appearance.

### BRIEF DESCRIPTION OF THE DRAWINGS

FIGS. 1A and 1B are perspective views showing a speaker box device according to one or more embodiments of the present disclosure from different perspectives;

FIGS. 2A and 2B show exploded views of a speaker box device, in which a lighting assembly is separated from the speaker box device, and components of the lighting assembly are separated from each other to clearly show its structure;

FIGS. 3A and 3B are assembled sectional views of a lighting assembly;

FIG. 4A is a perspective sectional view of a speaker box device according to one or more embodiments of the present disclosure;

FIG. 4B is a partial enlarged view of the speaker box device of FIG. 4A;

FIG. 4C is a partial view of the speaker box device of FIG. 4A;

FIG. 5A is a partial sectional view of the speaker box device taken along the longitudinal direction of the lighting assembly;

FIG. 5B is an enlarged view at the dashed box A in FIG. 5A;

FIG. 6A is a sectional view of the speaker box device taken along a plane perpendicular to the longitudinal direction of the lighting assembly; and

FIG. 6B is an enlarged view at the dashed box in FIG. 6A.

### DETAILED DESCRIPTION

Embodiments of the present disclosure are described in detail below in conjunction with the drawings. The same or similar reference numerals in the drawings indicate the same or similar elements or elements with the same or similar functions. The embodiments described below with reference to the drawings are exemplary and are intended merely to explain the present disclosure, and shall not be understood as limitations of the present disclosure.

Unless otherwise defined, the technical terms or scientific terms used here should be the ordinary meanings understood by those of ordinary skill in the field of the present disclosure. In the description of the present disclosure, it should be understood that an orientation or positional relationship indicated by the terms "center," "longitudinal," "lateral," "upper," "lower," "front," "rear," "left," "right," "vertical," "horizontal," "top," "bottom," "inner," "outer," etc. is an orientation or positional relationship shown based on the accompanying drawings, is only for the convenience of describing the present disclosure and simplifying the description, rather than indicating or implying that a device or element referred to must have a specific orientation or be constructed and operated in a specific orientation, and therefore cannot be understood as a limitation to the present disclosure. In addition, the terms “first” and “second” are used for descriptive purposes only, and cannot be construed as indicating or implying relative importance.

The present disclosure provides a lighting assembly, including: an elongated light source panel provided with a plurality of light sources arranged along its longitudinal direction; an elongated reflector spaced apart from and arranged to face the light source panel and including a plurality of reflective structures arranged along its longitudinal direction; and a light diffuser, made of a translucent material, surrounding the light source panel and the reflector laterally, and having an inner surface extending between the light source panel and the reflector and an outer surface opposite to the inner surface.

In such a lighting assembly, light emitted by the elongated light source panel is uniformly distributed in the longitudinal direction of the lighting assembly through reflection by the reflective structure on the reflector. In addition, the light emitted from the light sources of the light source panel (after being reflected by the reflector) enters the light diffuser from the inner surface of the light diffuser and exits from the outer surface thereof. The translucent material of the light diffuser makes the light emitted by the light sources of the light source panel further uniformly distributed in the longitudinal direction of the lighting assembly.

According to one or more embodiments of the present disclosure, the plurality of reflective structures include a plurality of first reflective structures, each first reflective structure corresponding to one light source on the light source panel and arranged to face directly the corresponding light source. According to one or more embodiments of the present disclosure, the plurality of reflective structures further include a plurality of second reflective structures, the second reflective structure being arranged between two adjacent first reflective structures. The reflector configured in this way enables light emitted by the elongated light source panel to be further uniformly distributed in the longitudinal direction of the lighting assembly.

According to one or more embodiments of the present disclosure, the reflector is a formed part coated with a reflective coating. The reflector made in this way has the advantages of simple process, low cost and small thickness, thereby reducing the cost and volume of the lighting assembly.

The present disclosure provides an electronic device (e.g., a speaker box), including: a housing of the electronic device; a lighting assembly as described above, where the lighting assembly is mounted to the housing of the electronic device, and the housing of the electronic device has a transparent housing portion, with the outer surface of the light diffuser optically coupled to the transparent housing portion of the housing of the electronic device.

Through the optical coupling between the outer surface of the light diffuser of the lighting assembly and the transparent housing portion of the housing of the electronic device, the light exited from the outer surface of the light diffuser enters the transparent housing portion of the housing of the electronic device through the optical coupling, thereby realizing the lighting effect on the whole transparent housing portion of the housing of the electronic device. This improves the user experience.

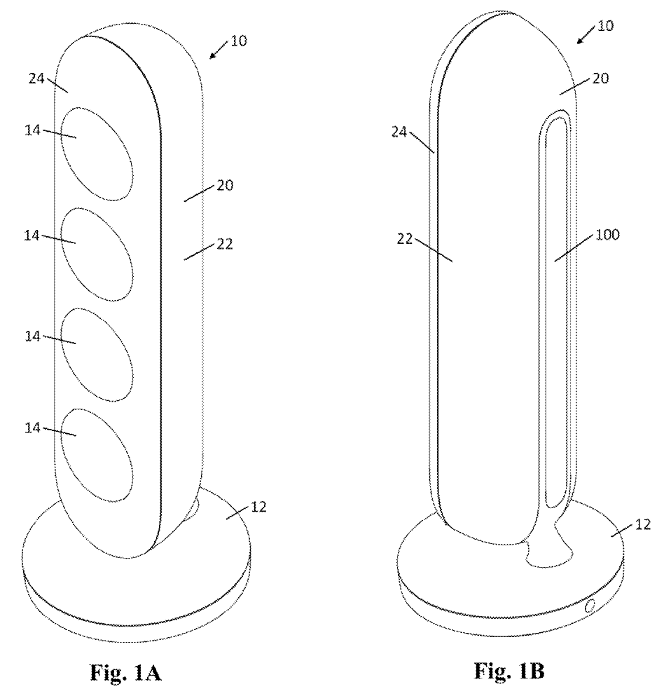

FIGS. 1A and 1B are perspective views showing a speaker box device 10 according to one or more embodiments of the present disclosure from different perspectives. The speaker box device 10 includes a speaker box base 12 and a speaker box housing 20 arranged on the speaker box base 12. The speaker box housing 20 includes a rear housing 22 and a front housing 24. The rear housing 22 and the front housing 24 of the speaker box housing 20 are assembled together to define an internal volume. Four speakers 14 are mounted on the front housing 24 of the speaker box housing 20 and are located in the internal volume defined by the speaker box housing 20. The speaker box device 10 also includes a lighting assembly 100 arranged on the rear housing 22 of the speaker box housing 20 for providing lighting effects to the speaker box device 10.

In the embodiment shown in FIGS. 1A and 1B, the speaker box device 10 is in the form of a satellite speaker box, having a speaker box base 12 and an elongated vertical speaker box body mounted on the speaker box base 12 and including four speakers 14 arranged in the vertical direction. However, the present disclosure is not limit thereto. In one or more embodiments according to the present disclosure, the speaker box device may be in any suitable form of speaker box, including but not limited to, a subwoofer, a surround speaker box, a pull-rod speaker box, a rectangular speaker box, a cylindrical speaker box, a spherical speaker box, etc. The speaker box device may also include any suitable number and form of speakers, such as a bass speaker, a mid-range speaker and a treble speaker.

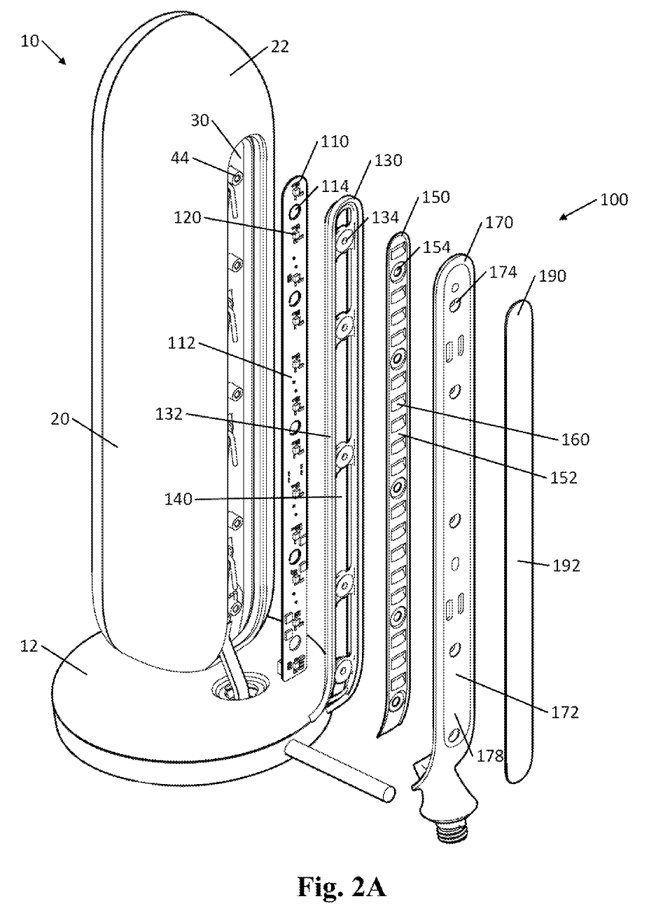

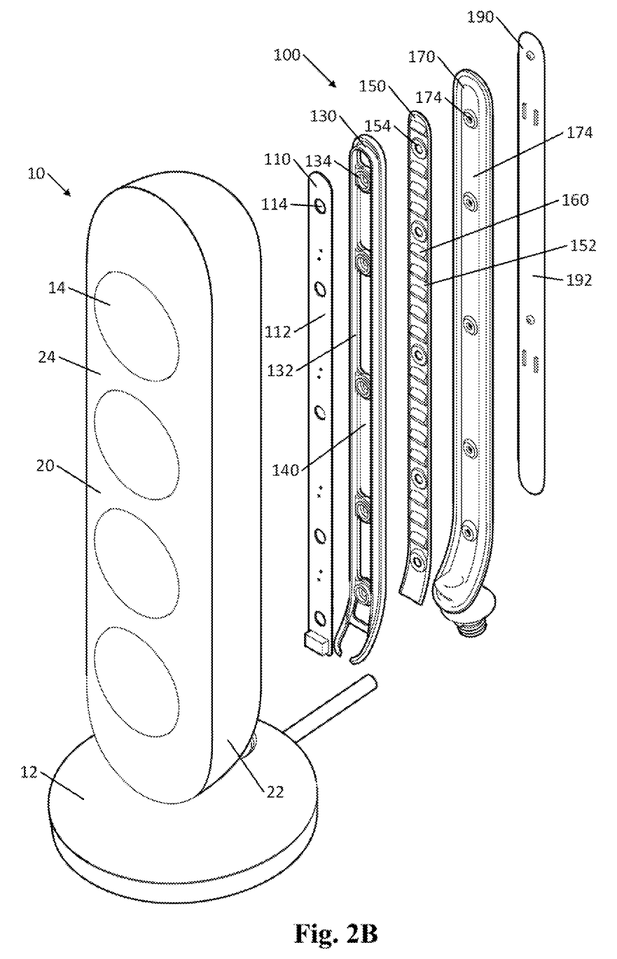

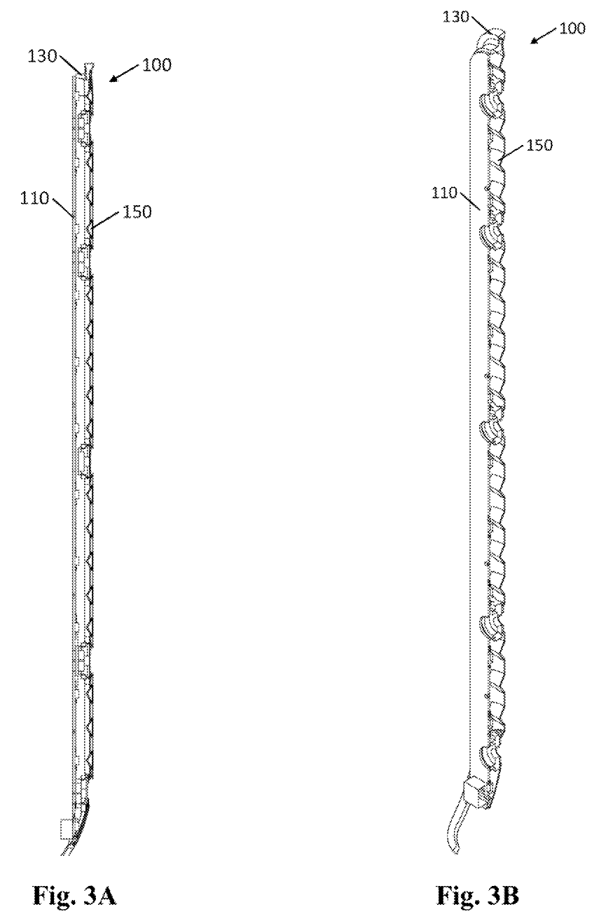

FIGS. 2A and 2B show exploded views of a speaker box device 10, in which a lighting assembly 100 is separated from the speaker box device 10, and components of the lighting assembly 100 are separated from each other to clearly show its structure. FIGS. 3A and 3B are assembled sectional views of the lighting assembly 100, some components of which are not shown to more clearly show the lighting assembly.

The lighting assembly 100 includes an LED panel 110, a light diffuser 130, a reflector 150, a support ridge 170, and a back cover 190. In the embodiment shown in the figure, the lighting assembly 100 has an elongated shape such that its LED panel 110, light diffuser 130, reflector 150, support ridge 170, and back cover 190 all have an elongated shape.

The LED panel 110 includes a circuit board 112 and a plurality of LED elements 120 arranged on the circuit board 112. In one or more embodiments according to the present disclosure, the plurality of LED elements 120 of the LED panel 110 are arranged at intervals in the longitudinal direction of the LED panel 110. A plurality of holes 114 are also arranged on the LED panel 110 for fixedly positioning the LED panel 110. The light diffuser 130 includes a light diffuser body 132 and a plurality of holes 134 formed on the light diffuser body 132. The light diffuser 130 also includes a plurality of openings 140 arranged at intervals in the longitudinal direction of the lighting assembly 100. The light diffuser 130 is made of a light-transmissive material, such as a translucent material or a transparent material, for diffusing light ray transmitted therethrough. In some embodiments, dispersed diffusing particles are also formed within the light diffuser 130 for further diffusing the light ray transmitted therethrough. In one or more embodiments, the light diffuser 130 may be made of any material suitable for diffusing or scattering the light ray transmitted therethrough. The reflector 150 includes a reflector body 152, a plurality of holes 154 formed on the reflector body 152, and a plurality of reflective structures 160 formed on the reflector body 152. The support ridge 170 includes a support ridge body 172 and a plurality of holes 174 formed on the support ridge body 172. The back cover 190 includes a back cover body 192.

As shown in the figures, the plurality of holes 114 of the LED panel 110, the plurality of holes 134 of the light diffuser 130, the plurality of holes 154 of the reflector 150, and the plurality of holes 174 of the support ridge 170 are of the same number and in corresponding positions such that in an assembled position of the speaker box device 10 or the lighting assembly 100, the holes 114, 134, 154 and 174 of the LED panel 110, the light diffuser 130, the reflector 150, and the support ridge 170 are in aligned positions. Fasteners (not shown), such as screws, may pass through the holes 114, 134, 154 and 174 of the LED panel 110, the light diffuser 130, the reflector 150, and the support ridge 170 and are threaded into respective threaded holes 44 of the speaker box housing 20 to fasten the LED panel 110, the light diffuser 130, the reflector 150, and the support ridge 170 to the speaker box housing 20 of the speaker box device 10. Herein, the length direction of the lighting assembly 100 may be referred to as the longitudinal direction thereof. The direction in which the LED panel 110, the light diffuser 130, the reflector 150, the support ridge 170 and the back cover 190 are stacked together, i.e., the direction in which the fasteners extend in the illustrated embodiment, may be referred to as the front-rear direction, where the direction towards the speaker 14 is a forward direction and the direction away from the speaker 14 is a backward direction. The direction perpendicular to both the longitudinal direction and the front-rear direction of the lighting assembly 100 may be referred to as the lateral direction.

The speaker box housing 20, specifically the rear housing 22 of the sound box housing 20, is formed with an open pore 30 shaped and sized to be adapted to the lighting assembly 100. When the lighting assembly 100 is connected to the speaker box housing 20, the speaker box housing 20 and the lighting assembly 100 form a continuous outer surface, providing an aesthetically pleasing appearance. A recess 178 is formed on the back of the support ridge 170. The recess 178 of the support ridge 170 is shaped and sized to correspond to the back cover 190. When the back cover 190 is connected to the support ridge 170, it can cover screws or the like that connect the lighting assembly 100 to the speaker box housing 20 and forming a continuous outer surface with the support ridge 170, providing an aesthetically pleasing appearance.

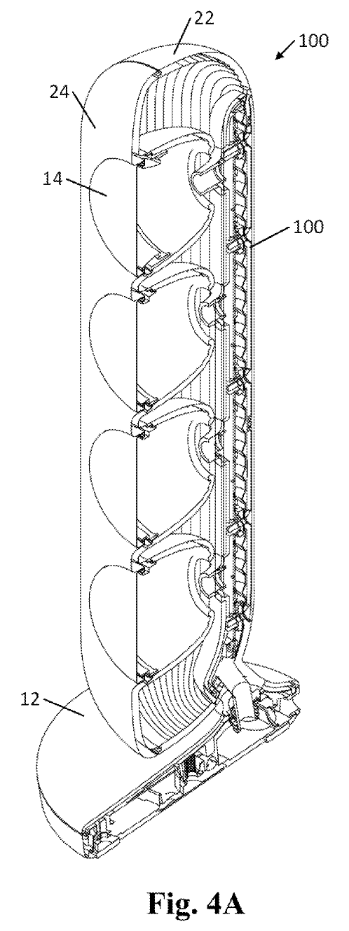

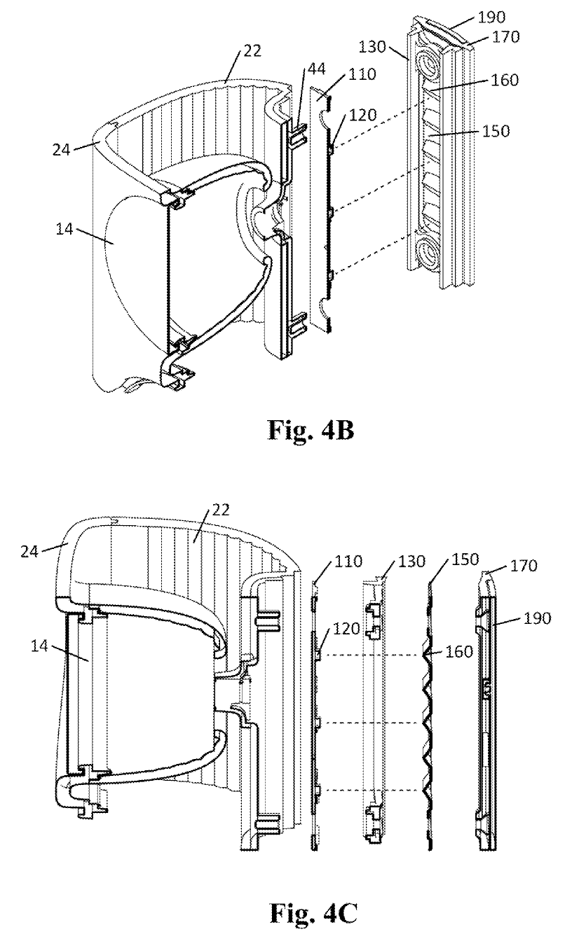

FIG. 4A is a perspective sectional view of a speaker box device 10 according to one or more embodiments of the present disclosure; FIG. 4B is a partial enlarged view of the speaker box device 10 of FIGS. 4A; and 4C; is a partial view of the speaker box device 10 of FIG. 4A; where some components of the lighting assembly are in a separated state from each other to more clearly show the internal structure of the lighting assembly 100.

As shown in the figures, in the lighting assembly 100, the LED element 120 on the LED panel 110 faces the reflective structure 160 on the reflector 150. The LED panel 110 includes a plurality of LED elements 120 arranged at intervals in the longitudinal direction of the lighting assembly 100. The reflector 150 includes a plurality of reflective structures 160 spaced apart in the longitudinal direction of the lighting assembly 100. In the assembled position of the lighting assembly 100, each LED element on the LED panel 110 is aligned with a reflective structure 160 on the reflector 150, as shown in dashed lines in FIGS. 4B and 4C. In the embodiment shown in the figure, the reflective structure 160 of the reflector 150 has a V-shaped structure with the vertices of the V-shaped structure facing directly the LED elements on the LED panel 110. Thus, when the LED element 120 emits light, the light emitted by it can be reflected by the reflective structure 160 facing it directly. Such reflection makes the light emitted by the LED elements 120 on the LED panel 110 more uniformly distributed, and in particular makes the light more uniformly distributed in the longitudinal direction of the lighting assembly 100. In one or more embodiments according to the present disclosure, the number of reflective structures 160 on the reflector 150 is greater than the number of LED elements 120 on the LED panel 110, so that some reflective structures 160 on the reflector 150 are not arranged in positions facing the LED elements 120 on the LED panel 110, but are arranged between two adjacent LED elements on the LED panel 110. In one or more embodiments according to the present disclosure, the reflector 150 may include one or two reflective structures 160 arranged at a position between two adjacent LED elements on the LED panel 110. The reflective structure 160 arranged at a position between two adjacent LED elements 120 on the LED panel 110 also serves to reflect light emitted by the LED elements so that the light emitted by the LED elements 120 on the LED panel 110 is more uniformly distributed. This configuration enables the lighting assembly 100 to obtain uniformly distributed light using a smaller number of LED elements 120, reducing its manufacturing and use costs.

According to one or more embodiments of the present disclosure, the reflector 150 is a formed part coated with a reflective coating. In some embodiments, the reflector 150 is formed by a formed plastic part coated with a reflective coating. In some other embodiments, the reflector 150 is formed by a stamped sheet metal which is preferably coated with a reflective coating. The reflector 150 thus manufactured has the advantages of simple process, low cost, and small thickness. In one or more other embodiments according to the present disclosure, the reflector 150 may be made by any suitable process. In one or more embodiments according to the present disclosure, the reflective structure 160 of the reflector 150 has a V-shaped cross-section for reflecting light emitted from the LED element 120 so that it is more uniformly distributed in the longitudinal direction of the lighting assembly 100. In one or more other embodiments according to the present disclosure, the reflective structure 160 of the reflector 150 may have any suitable structure and shape. In one or more embodiments according to the present disclosure, the reflector 150 includes one or two reflective structures 160 arranged at a position between two adjacent LED elements on the LED panel 110. In one or more other embodiments according to the present disclosure, the reflector 150 includes no reflective structure 160 at a position between two adjacent LED elements on the LED panel 110.

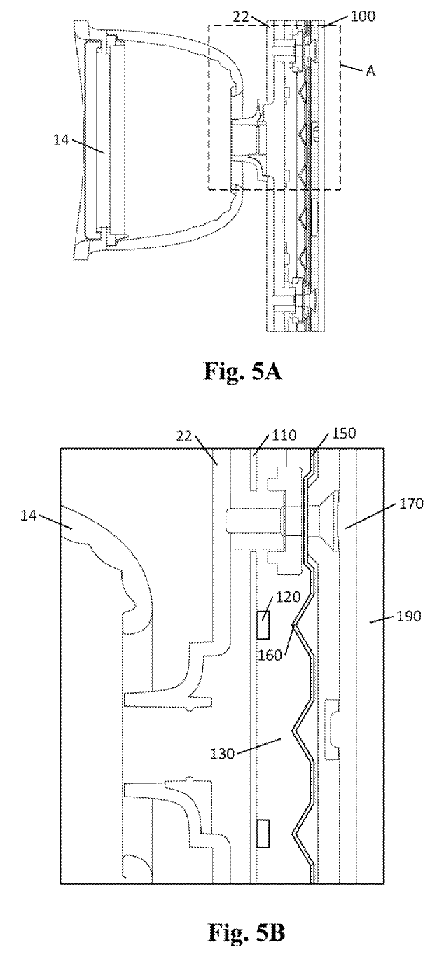

FIG. 5A is a partial sectional view of the speaker box device 10 taken along the longitudinal direction of the lighting assembly 100; and FIG. 5B is an enlarged view at the dashed box A in FIG. 5A. As shown in the figures, in the assembled position of the lighting assembly 100, the LED elements 120 of the LED panel 110 face directly the corresponding reflective structures 160 on the reflector 150 and are spaced apart from them by a distance. In one or more embodiments according to the present disclosure, the LED elements 120 of the LED panel 110 are located away from the corresponding reflective structures 160 on the reflector 150 by a small distance, e.g., 2mm-5mm, preferably 3-4mm. At such a distance, a great part of the light emitted from the LED elements 120 of the LED panel 110 is reflected by the corresponding reflective structures, so that the light emitted from the LED elements 120 is more uniformly distributed in the longitudinal direction of the lighting assembly 100. At the same time, this configuration allows a small thickness of the lighting assembly 100 in the front-rear direction, reducing the mounting space thereof.

According to one or more embodiments of the present disclosure, the light diffuser 130 includes a plurality of openings 140 arranged at intervals in the longitudinal direction of the lighting assembly 100 (see FIGS. 2A-2B). The light diffuser 130 is arranged such that the light diffuser body 132 surrounds the LED panel 110 and the reflector 150 laterally or on the lateral sides and each opening 140 of the light diffuser 130 is aligned with corresponding one or more LED elements 120 on the LED panel 110, so that the light emitted by the LED element 120 can be incident unimpeded on the reflector 150, such as the reflective structure 160 of the reflector 150, and thus reflected by the reflector 150.

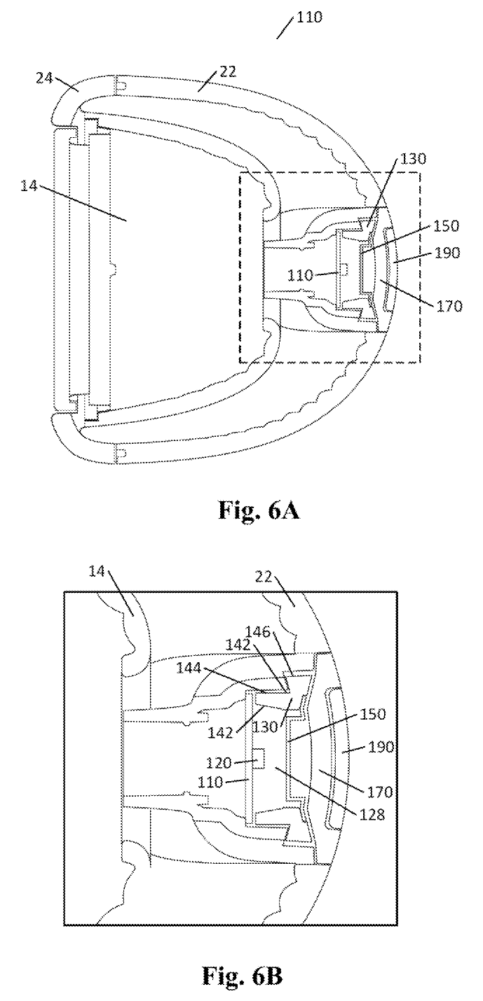

FIG. 6A is a sectional view of the speaker box device 10 taken along a plane perpendicular to the longitudinal direction of the lighting assembly 100; and FIG. 6B is an enlarged view at the dashed box in FIG. 6A. As shown in the figures, the LED panel 110 of the lighting assembly 100 and its LED elements 120 are spaced apart from the reflector 150, defining a reflection space 128 therebetween. Both sides of the reflection space 128 are surrounded and defined by the light diffuser 130 (the light diffuser body 132).

In one or more embodiments of the present disclosure, the LED element 120 of the LED panel 110 emits light, such as a divergent or tapered light beam. After the light emitted by the LED element 120 is reflected by the reflector 150 (e.g., the reflective structure 160), a part of the light enters the light diffuser body 132 through the inner surface 142 of the light diffuser body 132 and exits through the outer surfaces 144 and 146 of the light diffuser body 132. According to one or more embodiments of the present disclosure, the light diffuser 130 is made of a light-transmissive material, such as a translucent material or a transparent material, so that light transmitted therethrough can be diffused. In some embodiments, dispersed diffusing particles are also formed within the light diffuser 130 for further diffusing the light transmitted therethrough.

According to one or more embodiments of the present disclosure, the light diffuser body 132 of the light diffuser 130 forms a shoulder or step portion 142 on an outer side thereof. The shoulder or step portion 142 of the light diffuser 130 is configured to cooperate with a corresponding structure on the rear housing 22 of the speaker box housing 20 of the speaker box device 10, thereby realizing accurate positioning between the light diffuser 130 and the rear housing 22 of the speaker box housing 20. At this time, the outer surface 144 and the outer surface 146 of the light diffuser body 132 of the light diffuser 130 are closely adjacent to and facing the corresponding surfaces on the rear housing 22 of the speaker box housing 20. Thus, the light ray exited through the outer surfaces 144 and 146 of the light diffuser body 132 can enter the rear housing 22 of the speaker box housing 20. According to one or more embodiments of the present disclosure, the rear housing 22 of the speaker box housing 20 is made of a light-transmissive material or a transparent material so that light exiting from the outer surface 144 and the outer surface 146 of the light diffuser 130 and entering the rear housing 22 can be transmitted along the rear housing 22, so that the entire rear housing 22 of the speaker box housing 20 is illuminated, providing an enhanced lighting effect. According to one or more embodiments of the present disclosure, the inner surface of the rear housing 22 of the speaker box housing 20 is textured or rough to enhance the lighting effect of the speaker box device 10. According to one or more embodiments of the present disclosure, the inner surface 142 of the light diffuser 130 is inclined to enable more light to be guided to the rear housing 22 of the speaker box housing 20. According to one or more embodiments of the present disclosure, the support ridge 170 and/or the back cover 190 of the lighting assembly 100 are opaque such that light emitted by the LED elements 120 of the LED panel 110 of the lighting assembly 100 does not exit from the rear side (the support ridge 170 and the back cover 190) of the lighting assembly 100, but only from the outer surfaces 144 and 146 of the light diffuser body 132. Such a configuration further enhances the lighting effect of the speaker box device 10. According to one or more embodiments of the present disclosure, the intensity and color of the light emitted by the LED elements 120 of the LED panel 110 of the lighting assembly 100 vary with music played by the speaker box device 10. This further enhances the lighting effect of the speaker box device 10 and improves the user experience.

In the lighting assembly 100, the elongated LED panel 110 is provided with a plurality of LED elements 120 arranged along the length direction or the longitudinal direction thereof. The reflector 150 also of an elongated shape is provided with a plurality of reflective structures 160 arranged along the length direction or the longitudinal direction thereof. The light emitted by the LED elements 120 is uniformly distributed in the longitudinal direction of the lighting assembly 100 through reflection by the reflective structures 160 on the reflector 150. The lighting assembly 100 also includes a light diffuser 130, the light diffuser 130 being arranged to laterally surround the space between the LED panel 110 and the reflector 150. The light emitted from the LED elements 120 is reflected by the reflector 150, enters the light diffuser 130 from the inner surface 142 of the light diffuser 130, and exits from the outer surfaces 144 and 146 thereof. In one or more embodiments, the light diffuser 130 may be made of a translucent material such that the light emitted by the LED elements 120 is further uniformly distributed in the longitudinal direction of the lighting assembly 100. Further, the light exited from the outer surfaces 144 and 146 of the light diffuser 130 enters the rear housing 22 via respective surfaces on the rear housing 22 of the speaker box housing 20 optically coupled to the outer surfaces 144 and 146 (e.g., the two are closely adjacent and opposite to each other). The rear housing 22 may be made of a transparent or light-transmissive material such that light entering the rear housing 22 can be transmitted along the rear housing 22 to achieve a lighting effect on the whole rear housing 22. Therefore, the lighting assembly 100 of the present disclosure has a simple structure, low cost, and small footprint, and can achieve a lighting effect on the whole rear housing 22 at the same time, thereby improving user experience.

In the illustrated embodiment, the lighting assembly 100 includes an LED panel 110, a light diffuser 130, a reflector 150, a support ridge 170, and a back cover 190. The LED panel 110, the light diffuser 130, the reflector 150 and the support ridge 170 are provided with corresponding holes 114, 134, 154 and 174. The fasteners extend through these holes and are fastened to respective threaded holes 44 on the speaker box housing 20 to fasten the lighting assembly 100 to the speaker box housing 20. However, the present disclosure is not limit thereto. In one or more further embodiments according to the present disclosure, the lighting assembly 100 may employ other light sources than the LED elements. In the illustrated embodiment, the support ridge 170 provides the function of supporting and the back cover is primarily aesthetic. In one or more embodiments according to the present disclosure, the lighting assembly 100 may not include the support ridge and/or the back cover. In one or more further embodiments according to the present disclosure, the lighting assembly 100 may not include a separate support ridge and/or back cover, that is, the support ridge and/or back cover of the lighting assembly 100 may be formed integrally with other components, such as the reflector 150. In one or more other embodiments according to the present disclosure, the lighting assembly 100 may be fixed to the speaker box housing 20 via any suitable fastening structure, without using the fastening structure of fastener (e.g., a screw) and hole. In the embodiment shown in the figures, the lighting assembly 100 is used for a speaker box device. However, the present disclosure is not limit thereto. In one or more further embodiments according to the present disclosure, the lighting assembly 100 may be used for other electronic devices, provided that the housing of the electronic device also includes a transparent or light-transmissive material portion and the transparent or light-transmissive material portion thereof is optically coupled to the light diffuser of the lighting assembly 100.

The present disclosure can be implemented as follows:

Item 1: A lighting assembly, including: a light source panel having an elongated shape and provided with a plurality of light sources arranged along its longitudinal direction; a reflector having an elongated shape and spaced apart from and arranged to face the light source panel, the reflector including a plurality of reflective structures arranged along its longitudinal direction; and a light diffuser, made of a translucent material, surrounding the light source panel and the reflector laterally, and having an inner surface extending between the light source panel and the reflector and an outer surface opposite to the inner surface.

Item 2: The lighting assembly according to item 1, where the plurality of reflective structures include a plurality of first reflective structures, each first reflective structure corresponding to one light source on the light source panel and arranged to face directly the corresponding light source.

Item 3: The lighting assembly according to any of items 1-2, where the plurality of reflective structures further include a plurality of second reflective structures, the second reflective structure being arranged between two adjacent first reflective structures.

Item 4: The lighting assembly according to any of items 1-3, where the light source panel is an LED panel, and the light sources are LED elements.

Item 5: The lighting assembly according to any of items 1-4, where the plurality of reflective structures of the reflector are of V-shaped structures.

Item 6: The lighting assembly according to any of items 1-5, where the reflector is a formed part coated with a reflective coating.

Item 7: The lighting assembly according to any of items 1-6, where the lighting assembly is used for an electronic device, and the lighting assembly further includes a support ridge, the support ridge being adapted to fasten the light source panel, the reflector, and the light diffuser to a housing of the electronic device via fasteners.

Item 8: The lighting assembly according to any of items 1-7, where the fasteners are a plurality of screws, each of the screws passing through corresponding holes in the support ridge, the reflector, the light diffuser, and the light source panel, for fastening the lighting assembly to the housing of the electronic device.

Item 9: The lighting assembly according to any of items 1-8, further including a back cover configured to be connected to the support ridge.

Item 10: The lighting assembly according to any of items 1-9, where the electronic device is a speaker box.

Item 11: An electronic device, including: a housing of the electronic device; and a lighting assembly according to any of items 1-10, where the lighting assembly is mounted to the housing of the electronic device, and the housing of the electronic device has a transparent housing portion, with the outer surface of the light diffuser optically coupled to the transparent housing portion of the housing of the electronic device.

Item 12: The electronic device according to item 11, characterized in that the electronic device is a speaker box, the housing of the electronic device is a speaker box housing, and the speaker box includes one or more speakers.

Item 13: The electronic device according to any of items 11-12, where the speaker box housing includes a front housing and a rear housing, the lighting assembly being arranged on the rear housing, the rear housing including the transparent housing portion, and the one or more speakers being arranged on the front housing.

Item 14: The electronic device according to any of items 11-13, where the lighting assembly is arranged on the rear housing of the speaker box in a vertical direction.

Item 15: The electronic device according to any of items 11-14, where the lighting assembly further includes a support ridge, the support ridge configured to fasten the light source panel, the reflector, and the light diffuser to the housing of the electronic device via fasteners, and when the lighting assembly is connected to the electronic device, the housing of the electronic device and the lighting assembly form a continuous outer surface, providing an aesthetically pleasing appearance.

Item 16: The electronic device according to any of items 11-15, where the lighting assembly further includes a back cover, and the support ridge is provided with a recess shaped and sized to correspond to the back cover, so that when the back cover is connected to the support ridge, it forms a continuous outer surface with the support ridge, providing an aesthetically pleasing appearance.

Described above are merely example embodiments adopted to illustrate the principles of the present disclosure, and not intended to limit the protection scope of the present disclosure. For those of ordinary skill in the art, various modifications and improvements can be made without departing from the spirit and essence of the present disclosure, and these modifications and improvements are also within the protection scope of the present disclosure.

What is claimed is:

1. A lighting assembly, comprising:
a light source panel having an elongated shape and provided with a plurality of light sources arranged along its longitudinal direction;
a reflector having an elongated shape and spaced apart from and arranged to face the light source panel, the reflector comprising a plurality of reflective structures arranged along its longitudinal direction; and
a light diffuser, made of a translucent material, surrounding the light source panel and the reflector laterally, and having an inner surface extending between the light source panel and the reflector and an outer surface opposite to the inner surface.

2. The lighting assembly according to claim 1, wherein
the plurality of reflective structures comprise a plurality of first reflective structures, each first reflective structure corresponding to one light source on the light source panel and arranged to face directly the corresponding light source.

3. The lighting assembly according to claim 2, wherein
the plurality of reflective structures further comprise a plurality of second reflective structures, the second reflective structures being arranged between two adjacent first reflective structures.

4. The lighting assembly according to claim 1, wherein
the light source panel is an LED panel, and the light sources are LED elements.

5. The lighting assembly according to claim 1, wherein that the plurality of reflective structures of the reflector are of V-shaped structures.

6. The lighting assembly according to claim 1 wherein the reflector is a formed part coated with a reflective coating.

7. The lighting assembly according to claim 1, wherein
the lighting assembly is used for an electronic device, and
the lighting assembly further comprises a support ridge, the support ridge being adapted to fasten the light source panel, the reflector, and the light diffuser to a housing of the electronic device via fasteners.

8. The lighting assembly according to claim 7, wherein the fasteners are a plurality of screws, each of the screws passing through corresponding holes in the support ridge, the reflector, the light diffuser, and the light source panel, for fastening the lighting assembly to the housing of the electronic device.

9. The lighting assembly according to claim 7, wherein the lighting assembly further comprises a back cover configured to be connected to the support ridge.

10. The lighting assembly according to claim 7, wherein the electronic device is a speaker box.

11. An electronic device, comprising:
a housing of the electronic device; and
a lighting assembly, wherein the lighting assembly is mounted to the housing of the electronic device,
and
the housing of the electronic device has a transparent housing portion, with the outer surface of a light diffuser optically coupled to the transparent housing portion of the housing of the electronic device.

12. The electronic device according to claim 11, wherein the electronic device is a speaker box, the housing of the electronic device is a speaker box housing, and the speaker box comprises one or more speakers.

13. The electronic device according to claim 12, wherein the speaker box housing comprises a front housing and a rear housing, the lighting assembly being arranged on the rear housing, the rear housing comprising the transparent housing portion, and the one or more speakers being arranged on the front housing.

14. The electronic device according to claim 13, wherein the lighting assembly is arranged on the rear housing of the speaker box in a vertical direction.

15. The electronic device according to claim 11, wherein,
the lighting assembly further includes a light source panel, a reflector, and a support ridge, the support ridge being configured to fasten the light source panel, the reflector, and the light diffuser to the housing of the electronic device via fasteners, the support ridge configured to fasten the light source panel, the reflector, and the light diffuser to the housing of the electronic device via fasteners, and
when the lighting assembly is connected to the electronic device, the housing of the electronic device and the lighting assembly form a continuous outer surface.

16. The electronic device according to claim 15, wherein the lighting assembly further comprises a back cover, and the support ridge is provided with a recess shaped and sized to correspond to the back cover, so that when the back cover is connected to the support ridge, it forms a continuous outer surface with the support ridge, providing an aesthetically pleasing appearance.
